(19) United States
(12) Patent Application Publication
(10) Pub. No.: US 2018/0211672 A1
(43) Pub. Date: Jul. 26, 2018

(54) METHOD FOR PERFORMING AUDIO RESTAURATION, AND APPARATUS FOR PERFORMING AUDIO RESTAURATION

(71) Applicant: DOLBY INTERNATIONAL AB, Amsterdam Zuidoost (NL)

(72) Inventors: Cagdas BILEN, Rennes (FR); Alexey OZEROV, Rennes (FR); Patrick PEREZ, Rennes (FR)

(73) Assignee: Dolby International AB, Amsterdam Zuidoost (NL)

(21) Appl. No.: 15/564,378

(22) PCT Filed: Apr. 6, 2016
(86) PCT No.: PCT/EP2016/057541

§ 371 Date: Oct. 4, 2017

(30) Foreign Application Priority Data
Apr. 10, 2015 (EP) 15305537.1
Jul. 24, 2015 (EP) 15306212.0
Sep. 16, 2015 (EP) 15306424.1

(51) Int. Cl. G10L 19/005; G10L 19/032; G10L 21/0208

(52) U.S. Cl. CPC G10L 19/005; G10L 21/0208; G10L 19/032

(57) ABSTRACT

A method for performing audio inpainting, wherein missing portions in an input audio signal are recovered and a recovered audio signal is obtained, comprises computing a Short-Time Fourier Transform (STFT) on portions of the input audio signal, computing conditional expectations of the source power spectra of the input audio signal, wherein estimated source power spectra P(f, n, j) are obtained and wherein the variance tensor V and complex Short-Time Fourier Transform (STFT) coefficients of the input audio signals are used, iteratively re-calculating the variance tensor V from the estimated power spectra P(f, n, j) and re-calculating updated estimated power spectra P(f, n, j), computing an array of STFT coefficients Ⓢ from the resulting variance tensor V according to Ⓢ(f, n, j)=E{S(f, n, j)|x, Iₛ, I_{L}, V}, and converting the array of STFT coefficients Ⓢ to the time domain, wherein coefficients \tilde{s}₁, \tilde{s}₂, . . . , \tilde{s}ⱼ of the recovered audio signal are obtained.

### FIELD OF THE INVENTION

This invention relates to a method for performing audio restauration and to an apparatus for performing audio restauration. One particular type of audio restauration is audio inpainting.

### BACKGROUND

The problem of audio inpainting can be defined as the one of reconstructing the missing parts in an audio signal [1]. The name of “audio inpainting” was given to this problem to draw an analogy with image inpainting, where the goal is to reconstruct some missing regions in an image. A particular problem is audio inpainting in the case where some temporal samples of the audio are lost, ie. samples of the time domain. This is different from some known solutions that focus on lost samples in the time-frequency domain. This problem occurs e.g. in the case of saturation of amplitude (clipping) or interference of high amplitude impulsive noise (clicking). In such case, the samples need to be recovered (de-clipping or de-clicking respectively).

There exist methods for audio inpainting problems such as audio de-clipping [1], [2] and de-clicking [1]. In [1], audio inpainting is accomplished by enforcing sparsity of the audio signal in a Gabor dictionary which can be used both for audio de-clipping and de-clicking. For de-clipping, the approach proposed in [2] similarly relies on sparsity of audio signals in Gabor dictionaries while also optimizing for an adaptive sparsity pattern using the concept of social sparsity. Combined by the constraint of signal magnitude having to be greater than a clipping threshold, the method in [2] is shown to be much more effective than earlier works such as [1].

### SUMMARY OF THE INVENTION

The disclosed solution use a Non-negative Tensor Factorization (NTF) based model. It is expected to not only perform better than the known sparsity inducing approaches, but also to be computationally less expensive. Furthermore the approaches based on time domain sparse dictionaries such as Gabor dictionary do not inherently result in phase invariant results, whereas the NTF based model used herein is designed to be phase-invariant. This means that the models employed by the known methods need to be extended at the expense of performance in order to be near phase-invariant, whereas the proposed approach has no such drawback. Existing methods [1], [2] usually rely on some sparse models (i.e., the signal is represented with few activation coefficients in some dictionary of elementary signals) [1] or locally-structured sparse models (ie., relations between activation coefficients are locally enforced) [2]. The models exploiting some global audio signal structure (e.g., long-term similarity of time or frequency patterns) were not applied for these problems. According to the present principles, an audio inpainting method applied to recover (short) missing temporal parts is based on a Non-negative Tensor Factorization (NTF) model. This method is more efficient than the known methods [1], [2], since the NTF model exploits some global audio signal structure (notably the long-term similarity of frequency patterns) in the time domain. NTF-like models were already used for missing audio reconstruction in the time-frequency domain [3]. The main difference is that the known approaches assume the missing parts to be defined in some time-frequency domain, while the present principles consider missing temporal parts (ie. in the time domain).

An additional problem considered herein and not considered by earlier works is performing audio inpainting jointly with source separation. Source separation problem can be defined as separating an audio signal into multiple sources often with different characteristics, for example separating a music signal into signals from different instruments. When the audio to be inpainted is known to be a mixture of multiple sources and some information about the sources is available (e.g. temporal source activity information [4], [5]), it can be easier to separate the sources while at the same time explicitly modeling the unknown mixture samples as missing. This situation may happen in many real-world scenarios, e.g. when one needs separating a recording that was clipped, which happens quite often. It was found that a sequential application of inpainting and source separation in one order or another is suboptimal, since the latter stage processing will suffer from the errors produced on the former stage processing, while within the joint processing these errors may be compensated. Moreover, distortion such as clipping may have quite harmful impact on the audio signal in the Short-Time Fourier Transform (STFT) domain, thus possibly destroying the low-rank signal structure and making the NTF modeling poorer. Treating the clipped values as missing within the joint approach should avoid this problem. Disclosed herein is a method for audio inpainting that uses a low-rank NTF model to model the audio signals. The disclosed method does not rely on a fixed dictionary but instead relies on a more general model representing global signal structure, which is also automatically adapted to the reconstructed audio signals. In addition to being naturally extendable to handle the joint inpainting and source separation problem, the disclosed method is also highly parallelizable for faster and more efficient computation.

In one embodiment, the present invention relates to a method for performing audio restauration, wherein missing coefficients of an input audio signal are recovered and a recovered audio signal is obtained. The method comprises steps of initializing a variance tensor V such that it is a low rank tensor that can be composed from component matrices H,Q,W (or initializing said component matrices H,Q,W to obtain the low rank variance tensor V), iteratively applying the following steps, until convergence of the component matrices H,Q,W:

computing conditional expectations of source power spectra of the input audio signal, wherein estimated source power spectra P(f, n, j) are obtained and wherein the variance tensor V, known signal values of the input audio signal and time domain information on loss (I_{L}) are input to the computing, re-calculating the component matrices H,Q,W and the variance tensor V using the estimated source power spectra P(f, n, j) and current values of the component matrices H,Q,W, upon convergence of the component matrices H,Q,W, computing a resulting variance tensor V′, and computing from the resulting variance tensor V′, from known signal values (x,y) of the input audio signal and from time domain information on loss (I_{L}), an array of a posterior mean of Short Time Fourier Transform (STFT) samples (S) of the recovered audio signal, and converting coefficients of the array of the posterior mean of the STFT samples (S) to the time domain, wherein coefficients (\tilde{s}₁, \tilde{s}₂, . . . , \tilde{s}_{J}) of the recovered audio signal are obtained.

In one embodiment, the variance tensor V is initialized such that it can be composed from the component matrices H,Q,W and an additional covariance matrix R that is iteratively adapted.

In one embodiment, a computer readable medium has stored thereon executable instructions that when execution on a computer cause the computer to perform a method comprising steps of the method as disclosed in claim 1.

In one embodiment, an apparatus for performing audio inpainting comprises at least one of a hardware component and a hardware processor, and a non-transitory, tangible, computer-readable, storage medium tangibly embodying at least one software component, and the software component when executing on the at least one hardware component or hardware processor cause steps of the method of claim 1.

Further objects, features and advantages of the invention will become apparent from a consideration of the following description and the appended claims when taken in connection with the accompanying drawings.

### BRIEF DESCRIPTION OF THE DRAWINGS

Exemplary embodiments of the invention are described with reference to the accompanying drawings, which shows in

FIG. 1 the structure of audio inpainting;

FIG. 2 more details on an audio inpainting system;

FIG. 3 a flow-chart of a method; and

FIG. 4 elements of an apparatus.

### DETAILED DESCRIPTION OF EMBODIMENTS

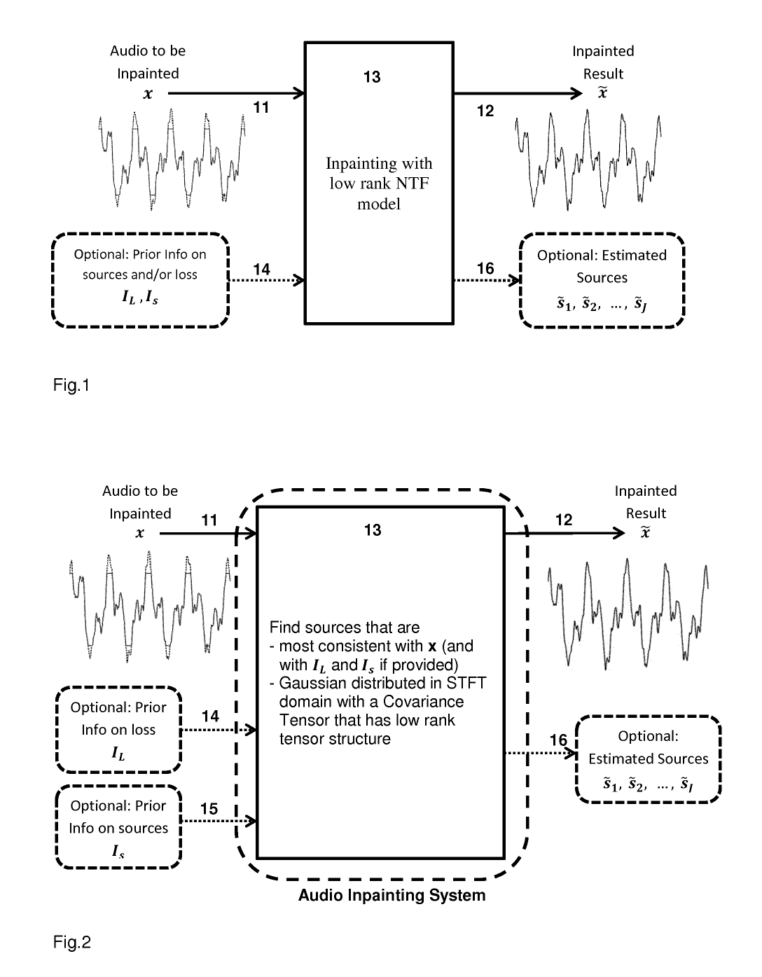

FIG. 1 shows the structure of audio inpainting. It is assumed that the audio signal x to be inpainted is given with known temporal positions of the missing samples. For the problem with joint source separation, some prior information for the sources can also be provided. E.g. some samples from individual sources may be provided, simply because they were kept during the audio mixing step or because some temporal source activity information was provided by a user, e.g. as described in [4], [5]. Additionally, further information on the characteristics of the loss in the signal x can also be provided. E.g. for the de-clipping problem, the clipping threshold is given so that the magnitude of the lost signal can be constrained, in one embodiment. Given the signal x, the problem is to find the inpainted signal \tilde{x} for which the estimated sections are to be as close as possible to the original signal before the loss (ie. before clipping or clicking). If some prior information on the sources is available, the problem definition can be extended to include joint source separation so that the individual sources are also estimated that are as close as possible to the original sources (before mixing and loss).

Throughout this specification, the time-domain signals will be represented by a letter with two primes, e.g. x″, framed and windowed time-domain signals will be denoted by a letter with one prime, e.g. x′, and complex-valued short-time Fourier transforms (STFT) coefficients will be denoted by a letter with no primes, e.g. x. The following is a single-channel mixing equation in the time domain:

xₜ″=Σⱼ₌₁^{J}sⱼₜ″+aₜ″,t=1, . . . ,T (1)

where t=1, . . . , T is the discrete time index, j=1, . . . , J is the source index, and xₜ″, sⱼₜ″ and aⱼₜ″ denote respectively mixture, source and quantization noise samples. Moreover, it is assumed that the mixture is only observed on a subset of time indices Ξ″⊂{1, . . . , T} called mixture observation support (MOS). For clipped signals this support indicates the indices with magnitude smaller than the clipping threshold. The sources are unknown. It is assumed, however, that it is known which sources are active at which time periods. For example for a multi instrument music, this information corresponds to knowing which instruments are playing at any instant.

Furthermore it is also assumed that if the mixture is clipped, the clipping threshold is known.

The time domain signals are converted into their windowed-time version using overlapping frames of length M. In this domain, mixing equation (1) reads

xₘₙ′=Σⱼ₌₁^{J}sⱼₘₙ′+aₘₙ′,m=1, . . . ,M,n=1, . . . ,N (2)

where n=1, . . . , N is the frame index and m=1, . . . , M is an index within the frame. We also introduce the set Ξₙ′⊂{1, . . . , Mt}×{1, . . . , Nt} that is the MOS within the framed representation corresponding to Ξ″ in the time domain, and its frame-level restriction Ξ′={m|(m,n)∈Ξ′}. In this specification, the observed clipped mixture in the windowed time domain will be denoted as x_{c}′ and its restriction to unclipped instants as x̅′, where x̅ₙ′=[xₘₙ′]_{m∈Ξ′}_{ₙ}′.

Let U∈ [symbol] ^{M×F} be the complex-valued Hermitian matrix of the Discrete Fourier Transform (DFT). Applying this transform to eq. (2) yields the STFT domain model:

x_{fn}=Σⱼ₌₁^{J}s_{jfn}+a_{fn},f=1, . . . ,F,n=1, . . . ,N (3)

where f=1, . . . , F is the frequency bin index, xₙ=Uxₙ′, sⱼₙ=Usⱼₙ′ and aₙ=Uaₙ′ are STFT frames (F-length column vectors) obtained from the corresponding time frames (M-length column vectors). For example, xₙ=[x_{fn}]_{f=1, . . . , F} is a mixture STFT frame and xₙ′=[xₘₙ′]_{m=1, . . . , M} is a mixture time frame. The sources are modelled in the STFT domain with a normal distribution (s_{jfn}˜N_{c}(0, v_{jfn})), where the variance tensor V=[v_{jfn}] has the following low-rank NTF structure

v_{jfn}=Σₖ₌₁^{K}qⱼₖw_{fk}hₙₖ, (4)

where k<max(J,F,N) and all the variables are non-negative reals. This model is parameterized by Θ={Q,W,H}, with Q=[qⱼₖ]_{j,k′}, W=[w_{fk}]_{f,k} and H=[hₙₖ]_{n,k} being, respectively, J×K, F×K and N×K non-negative matrices.

The assumed information on which sources are active at which time periods is captured by constraining certain entries of Q and H to be zero [5]. Each of the K components being assigned to a single source through Q(ψQ)=0 for some appropriate set ψ_{Q} of indices, the components of each source are marked as silent through H(ψH)=0 with an appropriate set ψ_{H} of indices.

Finally, for the sake of simplicity it is assumed that there is no mixture quantization (aₘₙ′=0). Note however that assuming a complex valued normal distribution instead for this error only requires minor changes. The problem at hand is now the estimation of the model parameters Θ and of the unknown un-clipped sources {sⱼₙ}ₙ, j=1, . . . , J, given the observed clipped mixture x_{c}′.

FIG. 2 shows more details on an exemplary audio inpainting system in a case where prior information on loss I_{L} and/or prior information on sources is are available. In one embodiment, the invention performs audio inpainting by enforcing a low-rank non-negative tensor structure for the covariance tensor of the Short-Time Fourier Transform (STFT) coefficients of the audio signal. It estimates probabilistically the most likely signal \tilde{x}, given the input audio x and some prior information on the loss in the signal I_{L}, based on two assumptions:

First assumption is that the sources are jointly Gaussian distributed in the Short-Time Fourier Transform (STFT) domain with window size F and number of windows N.
Second assumption is that the variance tensor of the Gaussian distribution, V∈R₊^{F×N×J}, has a low rank Non-Negative Tensor Decomposition (NTF) of rank K such that

V(f,n,j)=Σₖ₌₁^{K}H(n,k)W(f,k)Q(j,k),H∈R₊^{N×K},W∈R₊^{F×K},Q∈R₊^{J×K} (5)

Both assumptions are usually fulfilled. Further, estimation of the sources \tilde{s}₁, \tilde{s}₂, . . . , \tilde{s}_{J} is further improved if some prior information on the sources Iₛ is given.

In the following, the most general case will be described, wherein samples from multiple sources are available. In the case that information on multiple sources are not provided, one can simply assume that there is a single source J=1 and the known samples of the source coincide with the input audio signal. In an exemplary embodiment, an implementation of the invention can be summarized with the following steps:
1. Initialize the variance tensor V∈R₊^{F×N×J} by random matrices H∈R₊^{N×K}, W∈R₊^{F×K}, Q∈R₊^{J×K} such that:

$$V ( f , n , j ) = {\sum }_{k = 1}^{K} H ( n , k ) W ( f , k ) Q ( j , k ) \qquad ( 6 )$$

2. Until convergence or maximum number of iterations reached, repeat:
   2.1 Compute the conditional expectations of the source power spectra such that

P(f,n,j)=E{|S(f,n,j)|²|x,Iₛ,I_{L},V} (7)
where S∈C^{F×N×J} is the array of the STFT coefficients of the sources. This step can be performed for each STFT frame independently, hence providing significant gain by parallelism. More details on this posterior mean computation can be found below.
2.2 Re-estimate NTF model parameters H∈R₊^{N×K}, W∈R₊^{F×K}, Q∈R₊^{J×K} using the multiplicative update (MU) rules minimizing the Itakura-Saito divergence (IS divergence) [6] between the 3-valence tensor of estimated source power spectra P(f,n,j) and the 3-valence tensor of the NTF model approximation V(f,n,j) such that:

$$\begin{matrix}{Q}^{′ ( j , k )} ← Q ( j , k ) ( \frac{{\sum }_{f , n} W ( f , k ) H ( n , k ) P ( f , n , j ) {V ( f , n , j )}^{- 2}}{{\sum }_{f , n} W ( f , k ) H ( n , k ) {V ( f , n , j )}^{- 1}} ) & ( 8 ) \\ {W}^{′ ( f , k )} ← W ( f , k ) ( \frac{{\sum }_{j , n} Q ( j , k ) H ( n , k ) P ( f , n , j ) {V ( f , n , j )}^{- 2}}{{\sum }_{j , n} Q ( j , k ) H ( n , k ) {V ( f , n , j )}^{- 1}} ) & ( 9 ) \\ {H}^{′ ( n , k )} ← H ( n , k ) ( \frac{{\sum }_{f , j} W ( f , k ) Q ( j , k ) P ( f , n , j ) {V ( f , n , j )}^{- 2}}{{\sum }_{f , j} W ( f , k ) Q ( j , k ) {V ( f , n , j )}^{- 1}} ) & ( 10 )\end{matrix}$$

Then update V by

$${V}^{′ ( f , n , j )} = {\sum }_{k = 1}^{K} {H}^{′ ( n , k )} {W}^{′ ( f , k )} {Q}^{′ ( j , k )} \qquad ( 11 )$$

This can be repeated multiple times.
3. Compute the array of STFT coefficients S∈C^{F×N×J} as the posterior mean as

Ŝ(f,n,j)=E{S(f,n,j)|x,Iₛ,I_{L},V} (12)
and convert back into the time domain to recover the estimated sources \tilde{s}₁, \tilde{s}₂, . . . , \tilde{s}_{J}. Set the estimated signal as x=Σⱼ₌₁^{J} \tilde{s}ⱼ. More details on this posterior mean computation can be found below.

The following describes some mathematical basics on the above calculations.

A tensor is a data structure that can be seen as a higher dimensional matrix. a matrix is 2-dimensional, whereas a tensor can be N-dimensional. In the present case, V is a 3-dimensional tensor (like a cube) that represents the covariance matrix of the jointly Gaussian distribution of the sources.

A matrix can be represented as the sum of few rank-1 matrices, each formed by multiplying two vectors, in the low rank model. In the present case, the tensor is similarly represented as the sum of K rank one tensors, where a rank one tensor is formed by multiplying three vectors, e.g. hᵢ, qᵢ, and wᵢ. These vectors are put together to form the matrices H, Q and W. There are K sets of vectors for the K rank one tensors. Essentially, the tensor is represented by K components, and the matrices H, Q and W represent how the components are distributed along different frames, different frequencies of STFT and different sources respectively.

Similar to a low rank model in matrices, K is kept small because a small K better defines the characteristics of the data, such as audio data, e.g. music. Hence it is possible to guess unknown characteristics of the signal by using the information that V should be a low rank tensor. This reduces the number of unknowns and defines an interrelation between different parts of the data.

The steps of the above-described iterative algorithm can be described as follows. First, initialize the matrices H, Q and W and therefore V. Note that it is also possible to initialize V and then obtain the initial matrices H, Q and W from it, since H, Q and W directly define V. After the initialization, V always equals to the multiplied sum of H, Q and W, so it is a low rank tensor. If there is only one source, then Q does not exist (or equivalently can be set to be a constant), so that V is a low rank matrix. Note further that H, Q and W may also be called “model parameters” or “low-rank components” herein.

Given V, the probability distribution of the signal is known. And looking at the observed part of the signals (signals are observed only partially), it is possible to estimate the STFT coefficients Ŝ, e.g. by Wiener filtering. This is the posterior mean of the signal. Further, also a posterior covariance of the signal is computed, which will be used below. This step is performed independently for each window of the signal, and it is parallelizable. This is called the expectation step (E-step). The posterior mean \tilde{s}ⱼₙ and posterior covariance \hat{Σ}ₛ_{ⱼₙ}ₛ_{ⱼₙ} can be computed by

$$\begin{matrix}{\hat{s}}_{jn} = {\sum }_{{\overline{x}}_{n}^{′} {s}_{jn}}^{H} {\sum }_{{\overline{x}}_{n}^{′} {\overline{x}}_{n}^{′}}^{- 1} {\overline{x}}_{n}^{′} & ( 13 ) \\ {\sum }_{{s}_{jn} {s}_{jn}}^{\hat{}} = {\sum }_{{s}_{jn} {s}_{jn}} - {\sum }_{{\overline{x}}_{n}^{′} {s}_{jn}}^{H} {\sum }_{{\overline{x}}_{n}^{′} {\overline{x}}_{n}^{′}}^{- 1} {\sum }_{{\overline{x}}_{n}^{′} {s}_{jn}} & ( 14 )\end{matrix}$$

given the definitions

$$\begin{matrix}{\sum }_{{s}_{jn} {s}_{jn}} = diag ( {[ {v}_{jfn} ]}_{f} ) & ( 15 ) \\ {\sum }_{{\overline{x}}_{n}^{′} {s}_{jn}} = {U}^{H} ( {Ξ}_{n}^{′} ) diag ( {[ {v}_{jfn} ]}_{f} ) & ( 16 ) \\ {\sum }_{{\overline{x}}_{n}^{′} {\overline{x}}_{n}^{′}} = {U}^{H} ( {Ξ}_{n}^{′} ) diag ( {[ {\sum }_{j} {v}_{jfn} ]}_{f} ) U ( {Ξ}_{n}^{′} ) & ( 17 )\end{matrix}$$

where U(Ξₙ′) is the M×|Ξₙ′| matrix of columns from U with index in Ξₙ′. For a de-clipping application, it is also known that the estimated mixture must obey

$$\vert {U}^{H} ( {Ξ}_{n}^{′} ) {\sum }_{j} {\hat{s}}_{jn} \vert \geq \vert {x}_{c , jn}^{′} ( {Ξ}_{n}^{′} ) \vert \qquad ( 18 )$$

This is difficult to enforce directly into the model since posterior distribution of the sources under this prior would no longer be Gaussian. In order to find a workaround, let's suppose that eq. (18) is not satisfied at the indices \hat{Ξ}ₙ′. A simple way to enforce eq. (18) can be directly scaling up the magnitude of the sources at window indices \hat{Ξ}ₙ′ so that eq. (18) is satisfied.

The clipping constraint can be handled as follows.

In order to update the model parameters, one needs to estimate the posterior power spectra of the signal defined as \tilde{p}_{jfn}= [symbol] [|s_{jfn}|²x̅ₙ′; Θ]. For an audio inpainting problem without any further constraints, the posterior signal estimate ŝₙ and the posterior covariance matrix \hat{Σ}ₛ_{ₙ}ₛ_{ₙ} would be sufficient to estimate \tilde{p}_{fn} since the posterior distribution of the signal is Gaussian. However, in clipping, the original unknown signal is known to have its magnitude above the clipping threshold outside the OS, and so should have the reconstructed signal frames ŝₙ′=U^{H}ŝₙ:

ŝₘₙ′×sign(xₘₙ′)≥|xₘₙ′|,∀n,∀m,∉Ξₙ′

This constraint is difficult to enforce directly into the model since the posterior distribution of the signal under it is no longer Gaussian, which significantly complicates the computation of the posterior power spectra. In the presence of such constraints on the magnitude of the signal, various ways can be considered to approach the problem:

Unconstrained: The simplest way to perform the estimation is to ignore completely the constraints, treating the problem as a more generic audio inpainting in time domain. Hence during the iterations, the “constrained” signal is taken simply as the estimated signal, i.e. \tilde{s}ₙ=ŝₙ, n=1, . . . , N, as is the posterior covariance matrix, \tilde{Σ}ₛ_{ₙ}ₛ_{ₙ}=\hat{Σ}ₛ_{ₙ}ₛ_{ₙ}, n=1, . . . , N.

Ignored projection: Another simple way to proceed is to ignore the constraint during the iterative estimation process and to enforce it at the end as a post-processing of the estimated signal. In this case, the signal is treated the same as the unconstrained case during the iterations.

Signal projection: A more advanced approach is to update the estimated signal at each iteration so that the magnitude obeys the clipping constraints. Let's suppose eq. (18) is not satisfied at the indices in set Ξₙ′. We can set \tilde{s}ₙ′=ŝₙ′ and then force \tilde{s}ₙ′(\hat{Ξ}ₙ′)=x_{c,n}′(\hat{Ξ}ₙ′). However, this approach does not update the posterior covariance matrix, ie. \tilde{Σ}ₛ_{ₙ}ₛ_{ₙ}=\hat{Σ}ₛ_{ₙ}ₛ_{ₙ}, n=1, . . . , N, which is needed to compute the posterior power spectra of the sources to update the NTF model.

Covariance projection: In order to update as well the posterior covariance matrix, we can re-compute the posterior mean and the posterior covariance by eq. (13) and (14) respectively. The posterior mean and the posterior covariance are simply re-computed with the above equations respectively, by using Ξₙ′═\hat{Ξ}ₙ′ instead of Ξₙ′, and x_{c,jn}′(Ξₙ′∪\hat{Ξ}ₙ′) instead of x̅ₙ′ in eq. (13)-(17).

If the resulting estimation of the sources violate eq. (18) on additional indices, \hat{Ξ}ₙ′ is extended to include these indices and the computation is repeated.

As a result, final sources estimates \tilde{s} that satisfy eq. (18) and the corresponding posterior covariance matrix \tilde{Σ}ₛ_{ₙ}ₛ_{ₙ} are obtained. Note that in addition to updating the posterior covariance matrix, this approach also updates the entire estimated signal and not just the signal at the indices of violated constraints.

Therefore the posterior power spectra \tilde{p}, which will be used to update the NTF model as described in the following, can be computed as

\tilde{p}_{fn}= [symbol] [|s_{fn}|²x̅ₙ′;Θ]≅|\tilde{s}_{fn}|²+\tilde{Σ}ₛ_{ₙ}ₛ_{ₙ}(f,f) (19)

Once the posterior mean and covariance are computed, these are used to compute the posterior power spectra p. This is needed to update the earlier model parameters, ie. H, Q and W.

NMF model parameters can be re-estimated using the multiplicative update (MU) rules minimizing the is divergence between the matrix of estimated signal power spectra \tilde{P}=[\tilde{p}_{fn}] and the NMF model approximation V=WH^{T}:

$${D}_{IS} ( \tilde{P} \vert \vert V ) = {\sum }_{f , n} {d}_{IS} ( {\tilde{p}}_{fn} \vert \vert {v}_{fn} ) \\ where {d}_{IS} ( x \vert \vert y ) = \frac{x}{y} - log ( x / y ) - 1 \qquad ( 20 )$$

is the Iₛ divergence, and \tilde{p}_{fn} and v_{fn} are specified respectively by (19) and (12). Hence the model parameters can be updated as

$$\begin{matrix}{w}_{f k} ← {w}_{fk} ( \frac{{\sum }_{n} {h}_{nk} {\tilde{p}}_{fn} {v}_{fn}^{- 2}}{{\sum }_{n} {h}_{nk} {v}_{fn}^{- 1}} ) & ( 21 ) \\ {h}_{n k} ← {h}_{nk} ( \frac{{\sum }_{f} {w}_{fk} {\tilde{p}}_{fn} {v}_{fn}^{- 2}}{{\sum }_{f} {w}_{fk} {v}_{fn}^{- 1}} ) & ( 22 )\end{matrix}$$

It may be advantageous to repeat this step more than once in order to reach a better estimate (e.g. 2-10 times). This is called the maximization step (M-step). Once the model parameters H, Q and Ware updated, all the steps (from estimating the STFT coefficients Ŝ) can be repeated until some convergence is reached, in an embodiment. After the convergence is reached, in an embodiment the posterior mean of the STFT coefficients Ŝ is converted into the time domain to obtain an audio signal as final result.

The approximation of S and P, as described above, is based on the following basic idea. An exact computation of P normally relies on the assumption that the signal is Gaussian distributed with zero mean. When the distribution is Gaussian, posterior mean and posterior variance of the signal are enough to compute P. However, when some constraints exist, like information on loss I_{L}, the distribution is not Gaussian any more. With the true distribution, an exact computation of P(f,n,j)=E{|S(f,n,j)|²|x, Iₛ, I_{L}, V} is computationally not viable. According to the present principles, the posterior estimate Ŝ(f,n,j) is computed, and then the time domain signal is projected to the subspace satisfying the information on loss I_{L}. After that, it is assumed that the modified values (the values of Ŝ not obeying I_{L}) are known for that iteration. When these values are assumed to be known to their current values, the rest of the unknowns can be assumed to be Gaussian again, and corresponding posterior mean and posterior variance can be computed. By using this, P can also be computed. Note that the values that are assumed to be known are only an approximation, so that P is also an approximation. However, P is altogether much more accurate than if the information on loss I_{L} would be ignored.

For information on loss I_{L}, one example is the clipping threshold. If the clipping threshold thr is known, such that the unknown values of the time domain signal sᵤ is known to be sᵤ>thr if sᵤ>0, and sᵤ<−thr if sᵤ<0 for a known threshold thr. Other examples for information on loss I_{L} are the sign of the unknown value, an upper limit for the signal magnitude (essentially the opposite of the first example), and/or the quantized value of the unknown signal, so that there is the constraint thr₂<sᵤ<thr₁. All these are constraints in the time domain. No other method is known that can enforce them in a low rank NTF/NMF model enforced on the time frequency distribution of the signal. At least one or more of the above examples, in any combination, can be used as information on loss I_{L}.

For information on sources Iₛ, one example is information about which sources are active or silent for some of the time instants. Another example is a number of how many components each source is composed in the low rank representation. A further example is specific information on the harmonic structure of sources, which can introduce stronger constraints on the low rank tensor or on the matrix. These constraints are often easier to apply on the STFT coefficients or directly on the low rank variance tensor of the STFT coefficients or directly on the model, ie. on H, Q and W.

One advantage of the invention is enabling efficient recovery of missing portions in audio signals that resulted from effects such as clipping and clicking.

A second advantage of the invention is the possibility of jointly performing inpainting and source separation tasks without the need for additional steps or components in the methodology. This enables the possibility of utilizing the additional information on the components of the audio signal for a better inpainting performance.

Further, a third advantage is making use of the NTF model and hence efficiently exploiting the global structure of an audio signal for an improved inpainting performance.

A fourth advantage of the invention is that it allows joint audio inpainting and source separation, as described below.

As another advantage, the above can be extended also to multichannel audio. In the single channel formulation, the STFT domain signal and the mixture are considered as of size M×N×J and M×N respectively such that:

s∈ [symbol] ^{M×N×J},x∈ [symbol] ^{M×N},xₘₙ=Σⱼ₌₁^{J}sₘₙⱼ (23)

where M is the STFT window size, N is the number of windows along the time axis and J is the number of sources. The sources are modeled to be independently Gaussian distributed such that

sₘₙⱼ˜ [symbol] (0,Vₘₙⱼ),V∈ [symbol] ₊^{M×N×J} (24)

and the tensor V is modeled to have a low rank Non-negative Tensor Factorization (NTF) decomposition that is defined by the parameters W∈ [symbol] ₊^{M×K}, H∈ [symbol] ₊^{N×K}, Q∈ [symbol] ₊^{J×K} as

_i Vₘₙⱼ=Σₖ₌₁^{K}WₘₖHₙₖQⱼₖ (25)

where the number of components K is sufficiently small.

In one embodiment, multichannel audio is used. In the multichannel formulation, there is an additional dimension, namely the number of channels I, such that

s∈ [symbol] ^{M×N×J×I},x∈ [symbol] ^{M×N×I},xₘₙᵢ=Σⱼ₌₁^{J}sₘₙⱼᵢ (26)

The sources in each channel are not distributed independently, but instead as:

{sₘₙⱼᵢ}ᵢ₌₁^{I}=sₘₙⱼ˜ [symbol] (0,VₘₙⱼRₘⱼ),V∈ [symbol] ₊^{M×N×J},Rₘⱼ=E{sₘₙⱼ^{H}sₘₙⱼ}∈ [symbol] ^{I×I} (27)

Hence, in addition to the model parameters W∈ [symbol] ₊^{M×K}, H∈ [symbol] ₊^{N×K}, Q∈ [symbol] ₊^{J×K}, the covariance matrices between the channels {Rₘⱼ}_{m=1,j=1}^{m=M,j=J} must also be estimated during optimization.

An initial assumption is that the multichannel signal xᵢₜ″ is clipped everywhere except a so-called observation support (OS) Ξ″⊂{1, . . . , I}×{1, . . . , T}. The model is described by

xᵢₜ″=Σⱼ₌₁^{J}sᵢⱼₜ″ (27)

x_{fn}=Σⱼ₌₁^{J}s_{jfn} (28)

s_{jfn}˜ [symbol] _{c}(0,R_{jf}v_{jfn}) (29)

v_{jfn}=Σₖ₌₁^{K}qⱼₖw_{fk}hₙₖ (30)

with Q={qⱼₖ}_{j,k}, W={h_{fk}}_{f,k} and H={hₙₖ}_{n,k} being, respectively, J×K, F×K and N×K nonnegative matrices. Model parameters are then Θ={Q, W, H, {R_{if}}_{j,f}}.
We write

x̅ᵢₙ′=[x̅₁ₙ′^{T},x̅₂ₙ′^{T}, . . . ,x̅_{In}′^{T}]^{T}=[xᵢₘₙ′]_{m∈Ξ′}_{ᵢₙ} (31)

For the estimation of the signal, we can write the posterior distribution of each source image time-frequency vector y_{jfn} given the corresponding observed frame x̅ₙ′ and NMF model Θ as

$${s}_{jfn} \vert {\overline{x}}_{n}^{′} ; Θ \sim {𝒩}_{c} ( {\hat{s}}_{jfn} , {\sum }_{{s}_{jfn} {s}_{jfn}}^{\hat{}} )$$

with ŝ_{jfn} and

$${\sum }_{{s}_{jfn} {s}_{jfn}}^{\hat{}}$$

being, respectively, posterior mean and posterior covariance matrix. Each of them can be computed by Wiener filtering (where a^{H} represents the conjugate transpose of the vector or matrix a) as

$$\begin{matrix}{\hat{s}}_{jfn} = {\sum }_{{\overline{x}}_{n}^{′} {s}_{jfn}}^{H} {\sum }_{{\overline{x}}_{n}^{′} {\overline{x}}_{n}^{′}}^{- 1} {\overline{x}}_{n}^{′} & ( 32 ) \\ {\sum }_{{s}_{jfn} {s}_{jfn}}^{\hat{}} = {\sum }_{{s}_{jfn} {s}_{jfn}} - {\sum }_{{\overline{x}}_{n}^{′} {s}_{jfn}}^{H} {\sum }_{{\overline{x}}_{n}^{′} {\overline{x}}_{n}^{′}}^{- 1} {\sum }_{{\overline{x}}_{n}^{′} {s}_{jfn}}^{ } & ( 33 )\end{matrix}$$

given the definitions

$$\begin{matrix}{\sum }_{{s}_{jfn} {s}_{jfn}} {=}^{△} {R}_{jf} {v}_{jfn} , & ( 34 ) \\ {\sum }_{{\overline{x}}_{n}^{′} {s}_{j \vert fn}} {=}^{△} {\tilde{U} ( {Ξ}_{n}^{′} )}^{H} {A}_{jn} ( : , [ f , I + f , … , I - 1 + f ] ) , & ( 35 ) \\ {\sum }_{{\overline{x}}_{n}^{′} {\overline{x}}_{n}^{′}} {=}^{△} {\tilde{U} ( {Ξ}_{n}^{′} )}^{H} {\sum }_{j} {A}_{jn} \tilde{U} ( {Ξ}_{n}^{′} ) , & ( 36 ) \\ where {A}_{jn} {=}^{△} [ {diag ( {[ {R}_{jf} ( k , l ) {s}_{jfn}^{′} ]}_{f} )}_{k , l} ] , & \end{matrix}$$

Ũ(Ξₙ′) [symbol] diag ([U(Ξᵢₙ′)]ᵢ) is an IF×|Ξᵢₙ′| matrix, and U(Ξᵢₙ′) is the F×|Ξᵢₙ′| matrix formed by columns from U with index in Ξᵢₙ′.

The model estimation is done according to

Ĉₛ_{_{jfn}}ₛ_{_{jfn}}=ŝ_{jfn}ŝ_{jfn}^{H}+\hat{Σ}ₛ_{_{jfn}}ₛ_{_{jfn}} (37)

leading to the following updates:

$$\begin{matrix}{R}_{jf} = \frac{1}{N} {\sum }_{n} \frac{1}{{v}_{jfn}} {\hat{C}}_{{s}_{jfn} {s}_{jfn}} & ( 38 ) \\ {\hat{p}}_{jfn} = \frac{1}{I} tr [ {R}_{jf}^{- 1} {\hat{C}}_{{s}_{jfn} {s}_{jfn}} ] & ( 39 ) \\ {q}_{jk} ← {q}_{jk} ( \frac{{\sum }_{f , n} {w}_{fk} {h}_{nk} {\hat{p}}_{jfn} {v}_{jfn}^{- 2}}{{\sum }_{f , n} {w}_{fk} {h}_{nk} {v}_{jfn}^{- 1}} ) & ( 40 ) \\ {w}_{fk} ← {w}_{fk} ( \frac{{\sum }_{j , n} {h}_{nk} {q}_{jk} {\hat{p}}_{jfn} {v}_{jfn}^{- 2}}{{\sum }_{j , n} {h}_{nk} {q}_{jk} {v}_{jfn}^{- 1}} ) & ( 41 ) \\ {h}_{nk} ← {h}_{nk} ( \frac{{\sum }_{j , f} {w}_{fk} {q}_{jk} {\hat{p}}_{jfn} {v}_{jfn}^{- 2}}{{\sum }_{j , f} {w}_{fk} {q}_{jk} {v}_{jfn}^{- 1}} ) . & ( 42 )\end{matrix}$$

These values qⱼₖ, w_{fk} and hₙₖ can then be used in the iteration as described above for single channel audio signals. The term C is an empirical covariance matrix, from which the terms P and R are computed. In the single channel case, P and C are identical, and R is 1. In the multichannel case however, P is an empirical posterior power spectrum, ie. the power spectrum after the removal of the correlation of sources between mixtures. The matrix R represents the relationship between the channels for each source. In multichannel audio, depending on the microphone locations recording each mixture (for instance this can be stereo left and right channels in a simple case), the individual sources recorded within each mixture are of different scale and of different time/phase shift, depending on the distances to the sources. Furthermore there can also be echoes or reverberations. The matrix R models these effects in the frequency domain as a correlation matrix.

In one embodiment, the matrices H and Q can be determined automatically when an Iₛ of the form of silenced periods of the sources are present. The Iₛ may include the information on which source is silent at which time periods. In the presence of such specific information, a classical way to utilize NMF is to initialize H and Q in such a way that predefined kᵢ components are assigned to each source. The improved solution removes the need for such initialization, and learns H and Q so that kᵢ needs not to be known in advance. This is made possible by 1) using time domain samples as input, so that STFT domain manipulation is not mandatory, and 2) constraining the matrix Q to have a sparse structure. This is achieved by modifying the multiplicative update equations for Q, as described above.

Further, in source separation applications using the NTF/NMF model it is often necessary to have some prior information on the individual sources. This information can be some samples from the sources, or knowledge about which source is “inactive” at which instant of time. However, when such information is to be enforced, it has always been the case that the algorithms needed to predefine how many components each source is composed of. This is often enforced by initializing the model parameters W∈ [symbol] ₊^{M×K}, H∈ [symbol] ₊^{N×K}, Q∈ [symbol] ₊^{J×K}, so that certain parts of Q and H are set to zero, and each component is assigned to a specific source. In one embodiment, the computation of the model is modified such that, given the total number of components K, each source is assigned automatically to the components rather than manually. This is achieved by enforcing the “silence” of the sources not through STFT domain model parameters, but through time domain samples (with a constrain to have time domain samples of zeros) and by relaxing the initial conditions on the model parameters so that they are automatically adjusted. A further modification to enforce a sparse structure on the source component distribution (defined by Q) is also possible by slightly modifying the multiplicative update equations above. This results in an automatic assignment of sources to components.

Further, the Non-negative tensor factorization (NTF) or Non-negative Matrix factorization (NMF) can be applied to improve dequantization of a quantized signal. As mentioned above, quantized signals can be handled by treating quantization noise as Gaussian. In a case where there are no other time domain losses, handling noisy signals with low rank NTF/NMF model is known. But since the present principles introduce a way to handle time domain constraints (with I_{L}), this provides an opportunity to handle the quantized signals in a better way. More specifically, when the quantization step sizes are known, the quantized time domain signals are known to obey constraints such that

quant_level_low<s<quant_level_high
where the upper and lower bounds (quant_level_low/high) are known. Hence, it is possible to enforce this constraint while applying the low rank NMF/NTF model.

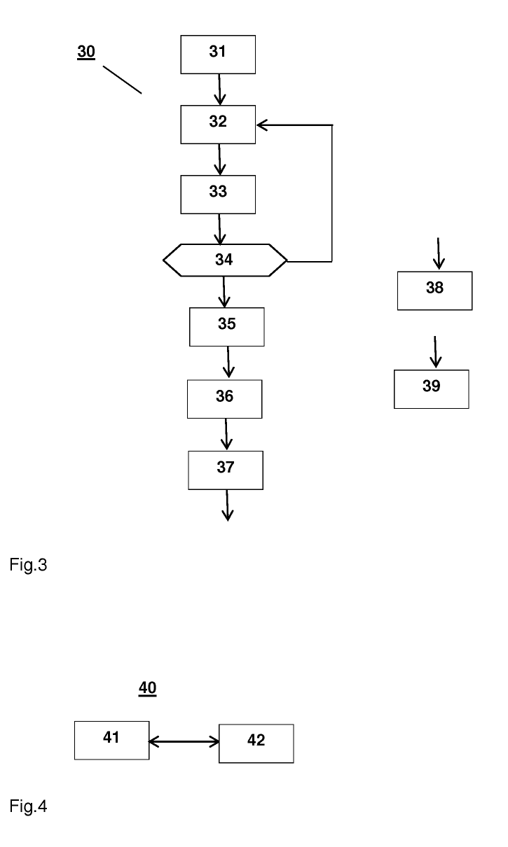

FIG. 3 shows, in one embodiment, a flow-chart of a method 30 for performing audio inpainting, wherein missing portions in an input audio signal are recovered and a recovered audio signal is obtained. The method comprises initializing 31 a variance tensor V such that it is a low rank tensor that can be composed from component matrices H,Q,W or initializing said component matrices H,Q,W to obtain the low rank variance tensor V, computing 32 of source power spectra of the input audio signal, wherein estimated source power spectra P(f,n,j) are obtained and wherein the variance tensor V, known signal values x,y of the input audio signal and time domain information on loss I_{L} are input to the computing, iteratively re-calculating 33 the component matrices H,Q,W and the variance tensor V using the estimated source power spectra P(f,n,j) and current values of the component matrices H,Q,W, and upon detecting convergence 34 of the component matrices H,Q,W or upon reaching a predefined maximum number of iterations, computing 35 a resulting variance tensor V′, and further computing 36 from the resulting variance tensor V′, known signal values x,y of the input audio signal and time domain information on loss I_{L}, an array of a posterior mean of Short Time Fourier Transform (STFT) samples S of the recovered audio signal, and converting 37 coefficients of the array of the posterior mean of the STFT samples S to the time domain, wherein coefficients \tilde{s}₁, \tilde{s}₂, . . . , \tilde{s}_{J} of the recovered audio signal are obtained.

In one embodiment, the estimated source power spectra P(f,n,j) are obtained according to P(f,n,j)=E{|S(f,n,j)|²|x, Iₛ, I_{L},V}, with Iₛ being time domain information on sources.

In one embodiment, the time domain information on sources Iₛ comprises at least one of: information about which sources are active or silent for a particular time instant, information about a number of how many components each source is composed in the low rank representation, and specific information on a harmonic structure of the sources.

In one embodiment, the time domain information on loss I_{L} comprises at least one of: a clipping threshold, a sign of an unknown value in the input audio signal, an upper limit for the signal magnitude, and the quantized value of an unknown signal in the input audio signal.

In one embodiment, the variance tensor V is initialized by random matrices H∈R₊^{N×K}, W∈R₊^{F×K}, Q∈R₊^{J×K}, as explained above.

In one embodiment, the variance tensor V is initialized by values derived from known samples of the input audio signal.

In one embodiment, the input audio signal is a mixture of multiple audio sources, and the method further comprises receiving 38 side information comprising quantized random samples of the multiple audio signals, and performing 39 source separation, wherein the multiple audio signals from said mixture of multiple audio sources are separately obtained.

In one embodiment, the STFT coefficients are windowed time domain samples Ŝ.

In one embodiment, the input audio signal contains quantization noise, wherein wrongly quantized coefficients take the position of the missing coefficients, wherein the quantization levels are used as further constraints in said time domain information on loss I_{L}, and wherein the recovered audio signal is a de-quantized audio signal.

FIG. 4 shows, in one embodiment, an apparatus 40 for performing audio restauration, wherein missing portions in an input audio signal are recovered and a recovered audio signal is obtained. The apparatus comprises a processor 41 and a memory 42 storing instructions that, when executed on the processor, cause the apparatus to perform a method comprising initializing a variance tensor V such that it is a low rank tensor that can be composed from component matrices H,Q,W, or initializing said component matrices H,Q,W to obtain the low rank variance tensor V, iteratively applying the following steps, until convergence of the component matrices H,Q,W:

computing 32 conditional expectations of source power spectra of the input audio signal, wherein estimated source power spectra P(f,n,j) are obtained and wherein the variance tensor V, known signal values x, y of the input audio signal and time domain information on loss (I_{L}) are input to the computing,
re-calculating 33 the component matrices H,Q,W and the variance tensor V using the estimated source power spectra P(f,n,j) and current values of the component matrices H,Q,W,
upon convergence of the component matrices H,Q,W_, computing a resulting variance tensor V′, and computing from the resulting variance tensor V′, known signal values x,y of the input audio signal and time domain information on loss I_{L}, an array of a posterior mean of Short Time Fourier Transform (STFT) samples S of the recovered audio signal, and converting 37 coefficients of the array of the posterior mean of the STFT samples S to the time domain, wherein coefficients \tilde{s}₁, \tilde{s}₂, . . . , \tilde{s}_{J} of the recovered audio signal are obtained.

In one embodiment, the estimated source power spectra P(f,n,j) are obtained according to P(f,n,j)=E{|S(f,n,j)|²|x, Iₛ, I_{L}, V} with is being time domain information on sources.

In one embodiment, the time domain information on loss comprises at least one of: a clipping threshold, a sign of an unknown value in the input audio signal, an upper limit for the signal magnitude, and the quantized value of an unknown signal in the input audio signal.

In one embodiment, the input audio signal is a mixture of multiple audio sources, and the instructions when executed on the processor further cause the apparatus to receive 38 side information comprising quantized random samples of the multiple audio signals, and perform 39 source separation, wherein the multiple audio signals from said mixture of multiple audio sources are separately obtained.

In one embodiment, the input audio signal contains quantization noise, wherein wrongly quantized coefficients take the position of the missing coefficients, wherein the quantization levels are used as further constraints in said time domain information on loss I_{L}, and wherein the recovered audio signal is a de-quantized audio signal.

In one embodiment, the input audio signal contains quantization noise, wherein wrongly quantized coefficients take the position of the missing coefficients, wherein the quantization levels are used as further constraints in said time domain information on loss I_{L}, and wherein the recovered audio signal is a de-quantized audio signal.

In one embodiment, an apparatus for performing audio restauration, wherein missing coefficients of an input audio signal are recovered and a recovered audio signal is obtained, comprises

first computing means for initializing 31 a variance tensor V such that it is a low rank tensor that can be composed from component matrices H,Q,W, or for initializing said component matrices H,Q,W to obtain the low rank variance tensor V, second computing means for computing 32 conditional expectations of source power spectra of the input audio signal, wherein estimated source power spectra P(f,n,j) are obtained and wherein the variance tensor V, known signal values x,y of the input audio signal and time domain information on loss I_{L} are input to the computing, calculating means for iteratively re-calculating 33 the component matrices H,Q,W and the variance tensor V using the estimated source power spectra P(f,n,j) and current values of the component matrices H,Q,W, detection means for detecting 34 convergence of the component matrices H,Q,W or for detecting that a predefined maximum number of iterations is reached, third computing means for computing 35, upon said convergence of the component matrices H,Q,W or upon reaching said predefined maximum number of iterations, a resulting variance tensor V′, fourth computing means for computing 36 from the resulting variance tensor V′, known signal values x,y of the input audio signal and time domain information on loss I_{L}, an array of a posterior mean of Short Time Fourier Transform (STFT) samples S of the recovered audio signal, and converter means for converting 37 coefficients of the array of the posterior mean of the STFT samples S to the time domain, wherein coefficients \tilde{s}₁, \tilde{s}₂, . . . , \tilde{s}_{J} of the recovered audio signal are obtained. The coefficients \tilde{s}₁, \tilde{s}₂, . . . , \tilde{s}_{J} of the recovered audio signal can be used e.g. to reproduce or store the recovered audio signal.

Usually, the invention leads to a low-rank tensor structure in the power spectrogram of the reconstructed signal.

The use of the verb “comprise” and its conjugations does not exclude the presence of elements or steps other than those stated in a claim. Furthermore, the use of the article “a” or “an” preceding an element does not exclude the presence of a plurality of such elements. Several “means” may be represented by the same item of hardware. Furthermore, the invention resides in each and every novel feature or combination of features. As used herein, a “digital audio signal” or “audio signal” does not describe a mere mathematical abstraction, but instead denotes information embodied in or carried by a physical medium capable of detection by a machine or apparatus. This term includes recorded or transmitted signals, and should be understood to include conveyance by any form of encoding, including pulse code modulation (PCM), but not limited to PCM.

While there has been shown, described, and pointed out fundamental novel features of the present invention as applied to preferred embodiments thereof, it will be understood that various omissions and substitutions and changes in the apparatus and method described, in the form and details of the devices disclosed, and in their operation, may be made by those skilled in the art without departing from the spirit of the present invention. It is expressly intended that all combinations of those elements that perform substantially the same function in substantially the same way to achieve the same results are within the scope of the invention. Substitutions of elements from one described embodiment to another are also fully intended and contemplated.

Each feature disclosed in the description and (where appropriate) the claims and drawings may be provided independently or in any appropriate combination. Features may, where appropriate be implemented in hardware, software, or a combination of the two. Connections may, where applicable, be implemented as wireless connections or wired, not necessarily direct or dedicated, connections. Reference numerals appearing in the claims are by way of illustration only and shall have no limiting effect on the scope of the claims. In one embodiment, an apparatus is at least partially implemented in hardware by using at least one silicon component.

### CITED REFERENCES

[1] A. Adler, V. Emiya, M. Jafari, M. Elad, R. Gribonval, and M. D. Plumbley, “Audio inpainting”, IEEE Transactions on Audio, Speech and Language Processing, vol. 20, no. 3, pp. 922-932, 2012.
[2] Kai Siedenburg, Matthieu Kowalski and Monika Dörfler, “Audio Declipping with Social Sparsity” in Proc. IEEE Int. Conf. on Acoustics, Speech, and Signal Processing (ICASSP), 2014.
[3] Smaragdis, P., B. Raj, M. Shashanka. “Missing data imputation for time-frequency representations of audio signals”, in the Journal of Signal Processing Systems. August 2010.
[4] A. Ozerov, C. Fevotte, R. Blouet, and J.-L. Durrieu, “Multichannel nonnegative tensor factorization with structured constraints for user-guided audio source separation”, in IEEE International Conference on Acoustics, Speech, and Signal Processing (ICASSP'11), Prague, May 2011, pp. 257-260.
[5] N. Q. K. Duong, A. Ozerov, and L. Chevallier, “Temporal annotation-based audio source separation using weighted nonnegative matrix factorization,” Proc. IEEE International Conference on Consumer Electronics (ICCE-Berlin), Germany, September 2014.
[6] C. Fevotte, N. Bertin, and J.-L. Durrieu, “Nonnegative matrix factorization with the Itakura-Saito divergence. With application to music analysis”, Neural Computation, vol. 21, no. 3, pp. 793-830, March 2009.

1. A method for performing audio restoration, wherein missing coefficients of an input audio signal are recovered and a recovered audio signal is obtained, comprising steps of
initializing at least one of a variance tensor V such that it is a low rank tensor that can be composed from component matrices H,Q,W, and said component matrices H,Q,W to obtain the low rank variance tensor V;
iteratively applying the following, until convergence of the component matrices H,Q,W:
i. determining conditional expectations of source power spectra of the input audio signal, wherein estimated source power spectra P(f, n, j) are obtained and wherein the variance tensor V, known signal values (x,y) of the input audio signal and time domain information on loss (I_{L}) are input to the computing;
ii. re-calculating the component matrices H,Q,W and the variance tensor V using the estimated source power spectra P(f, n, j) and current values of the component matrices H,Q,W;
upon convergence of the component matrices H,Q,W, computing a resulting variance tensor V′, and computing from the resulting variance tensor V′, signal values (x,y) of the input audio signal and time domain information on loss (I_{L}), an array of a posterior mean of Short Time Fourier Transform (STFT) samples (S) of the recovered audio signal; and
converting coefficients of the array of the posterior mean of the STFT samples (S) to the time domain, wherein coefficients (\tilde{s}₁, \tilde{s}₂, . . . , \tilde{s}_{J}) of the recovered audio signal are obtained.

2. The method according to claim 1, wherein in the determining conditional expectations of the source power spectra of the input audio signal the estimated source power spectra P(f, n, j) are based on P(f, n, j)=E{|S(f, n, j)|²|x, Iₛ, I_{L}, V}, wherein Iₛ is based on time domain information on sources.

3. The method according to claim 2, wherein the time domain information on sources (Iₛ) comprises at least one of: information about which sources are active or silent for a particular time instant, information about a number of how many components each source is composed in the low rank representation, and specific information on a harmonic structure of the sources.

4. The method according to claim 1, wherein the time domain information on loss (I_{L}) comprises at least one of: a clipping threshold, a sign of an unknown value in the input audio signal, an upper limit for the signal magnitude, and the quantized value of an unknown signal in the input audio signal.

5. The method according to claim 1, wherein the variance tensor V is based on matrices H∈R₊^{N×K}, W∈R₊^{F×K}, Q∈R₊^{J×K} of rank k according to V(f, n, j)=Σₖ₌₁^{K}H(n,k)W(f,k)Q(j,k).

6. The method according to claim 1, wherein the variance tensor V is initialized by random matrices H∈R₊^{N×K}, W∈R₊^{F×K}, Q∈R₊^{J×K}, according to
V(f,n,j)=Σₖ₌₁^{K}H(n,k)W(f,k)Q(j,k).

7. The method according to claim 1, wherein the variance tensor V is initialized by values derived from known samples of the input audio signal.

8. The method according to claim 1, wherein the input audio signal is a mixture of multiple audio sources, further comprising steps of
receiving side information comprising quantized random samples of the multiple audio signals; and
performing source separation, wherein the multiple audio signals from said mixture of multiple audio sources are separately obtained.

9. The method according to claim 1, wherein the STFT coefficients are windowed time domain samples (Ŝ).

10. The method according to claim 1, wherein the input audio signal contains quantization noise, wherein wrongly quantized coefficients take the position of the missing coefficients, wherein the quantization levels are used as further constraints in said time domain information on loss (I_{L}), and wherein the recovered audio signal is a de-quantized audio signal.

11. The method according to claim 1, wherein the input audio signal is a multichannel signal, further comprising a step of estimating covariance matrices {Rₘⱼ}_{m=1,j=1}^{m=M,j=J} between the channels of the multichannel signal by using a posterior mean ŝ_{jfn} and a posterior covariance matrix \hat{Σ}ₛ_{_{jfn}}ₛ_{_{jfn}} obtained by Wiener filtering the input audio signal, wherein coefficients of the covariance matrices are used in said step of computing the conditional expectations of source power spectra.

12. An apparatus for performing audio restoration, wherein missing coefficients of an input audio signal are recovered and a recovered audio signal is obtained, the apparatus comprising a processor and a memory storing instructions that, when executed on the processor, cause the apparatus to perform a method comprising
initializing at least one of a variance tensor V such that it is a low rank tensor that can be composed from component matrices H,Q,W, and said component matrices H,Q,W to obtain the low rank variance tensor V;
iteratively applying the following steps, until convergence of the component matrices H,Q,W:
i. determining conditional expectations of source power spectra of the input audio signal, wherein estimated source power spectra P(f, n, j) are obtained and wherein the variance tensor V, known signal values (x, y) of the input audio signal and time domain information on loss (I_{L}) are input to the computing;
ii. re-calculating the component matrices H,Q,W, and the variance tensor V using the estimated source power spectra P(f, n, j) and current values of the component matrices H,Q,W;
upon convergence of the component matrices H,Q,W_, computing a resulting variance tensor V′, and computing from the resulting variance tensor V′, known signal values (x,y) of the input audio signal and time domain information on loss (I_{L}), an array of a posterior mean of Short Time Fourier Transform (STFT) samples (S) of the recovered audio signal; and
converting coefficients of the array of the posterior mean of the STFT samples (S) to the time domain, wherein coefficients (\tilde{s}₁, \tilde{s}₂, . . . , \tilde{s}_{J}) of the recovered audio signal are obtained.

13. The apparatus according to claim 12, wherein the estimated source power spectra P(f, n, j) are obtained according to P(f, n, j)=E{|S(f, n, j)|²|x, Iₛ, I_{L},V} with Iₛ being time domain information on sources.

14. The apparatus according to claim 12, wherein the time domain information on loss comprises at least one of: a clipping threshold, a sign of an unknown value in the input audio signal, an upper limit for the signal magnitude, and the quantized value of an unknown signal in the input audio signal.

15. The apparatus according to claim 12, wherein the input audio signal is a mixture of multiple audio sources, the instructions when executed on the processor further cause the apparatus to
receive side information comprising quantized random samples of the multiple audio signals; and
perform source separation, wherein the multiple audio signals from said mixture of multiple audio sources are separately obtained.

16. The apparatus according to claim 12, wherein the input audio signal contains quantization noise, wherein wrongly quantized coefficients take the position of the missing coefficients, wherein the quantization levels are used as further constraints in said time domain information on loss (I_{L}), and wherein the recovered audio signal is a de-quantized audio signal.
